(19) United States
(12) Patent Application Publication
(10) Pub. No.: US 2006/0283455 A1
(43) Pub. Date: Dec. 21, 2006

(54) Convertible respiratory hood assembly

(76) Inventors: Garry J. Walker, Stockton-on-Tees (GB); Christopher P. Henderson, County Durham (GB)

Correspondence Address: 3M INNOVATIVE PROPERTIES COMPANY, PO BOX 33427, ST. PAUL, MN, 55133-3427, US

(21) Appl. No.: 11/153,809

(22) Filed: Jun. 15, 2005

(51) Int. Cl. A62B 18/08; A62B 17/04; A62B 17/00; A62B 23/02

(52) U.S. Cl. 128/206.24; 128/201.22; 128/201.23; 128/201.29; 128/205.27; 128/205.28; 128/205.29; 128/206.12; 128/206.16; 128/206.17; 128/206.21; 128/206.23; 128/206.28

(57) ABSTRACT

A respirator hood assembly comprises a pliable hood including a transparent viewing area and a removable support structure mountable within an interior of the hood, wherein the support structure draws taut the pliable hood to inhibit the formation of creases in the transparent viewing area.

### BACKGROUND

Respirator hoods are used for respiratory protection and to keep a worker's face, head, and hair free from contamination. Respirator hoods reduce the risk of skin absorption of chemicals. Respirator hoods provide the advantage of covering the entire face and head of a worker, as small respirator devices for the face do not work for people who have facial hair, abnormally sized facial features, or other features that may increase the difficulty of achieving a proper seal around the mouth and nose of the worker. Conversely, full body respirator suits are bulky and cumbersome, often interfering with the movement of the wearer. Further, The cost associated with full body suits detracts from their use where a hood will provide adequate protection.

Respirator hoods cover the head and neck of a wearer. A shroud portion can be draped around the shoulders of a wearer to provide a seal about the person. Further, an additional inner shroud may be tucked into the other garments of the wearer to provide additional protection. Typically, the hood does not provide hit impact protection. Respirator hoods are often made to be flexible. Air is typically supplied into the hood via a hose attached to the front or back. Such respirator hoods are available from many manufacturers, including Minnesota Mining and Manufacturing Company of St. Paul, Minn. The hoods are typically made from a non-woven material having a polymeric coating on the surface. Hoods can also be made from paper, cloth, or additional polymers. Often, the material chosen for the hood prevents the flow of fluids through the material.

In most cases, at least a portion of the hood is transparent. This transparent portion is typically located in an area that will allow the wearer to view the surrounding environment. The hood provides upper body protection against splash hazards, as well as provides the wearer with a field of vision. Respirator hoods may be used in combination with head gear, such as a head suspension or a hard cap. The head suspension or hard cap supports the hood on the head of the wearer and establishes at least a minimal space between the face of the wearer and the hood. The hood may be attached to the head gear in a detachable manner.

The structure of the hard cap may add some definition to the shape of the hood. Even with either a hard cap or a head suspension inserted in the hood, the material of the hood may be sufficiently flexible to allow a wearer access in and out of tight areas that would not be possible for the wearer to observe if the hood was of an inflexible construction. Due to this flexibility of the hood material, hoods often contain creases in the line of vision of the wearer which may impair the vision of the wearer at times.

### SUMMARY OF THE INVENTION

In one embodiment, a respirator hood assembly comprises a pliable hood including a transparent viewing area and a removable stiffening support structure mountable within an interior of the hood, wherein the support structure draws taut the pliable hood to inhibit the formation of creases in the transparent viewing area.

In another embodiment, the invention is an improvement for a respirator hood assembly having a gas impermeable hood made of a flexible material, the material of the gas impermeable hood having a transparent viewing area, a filtered air inlet to receive breathable air into the hood, at least one check valve for facilitating the exhausting of gas from the hood, and a portion for securing the hood about a head of a wearer. The improvement comprises a removable stiffening support structure attached within an interior of the hood, the support structure being sufficiently rigid to maintain the hood in an expanded upright position and to draw taut the transparent viewing area to enhance wearer viewability therethrough.

In another embodiment, a respirator hood assembly comprises a flexible hood structure having a first condition wherein the hood structure is collapsed for storage and transport and a second condition wherein the hood structure is expanded for respiratory use. The respirator hood assembly also comprises a removable stiffening support structure for the hood structure which, when attached to the hood structure, places the hood structure in the second condition whereby at least a front portion of the hood structure including a transparent viewing area and sides of the hood structure are drawn taut, and means for attaching the removable stiffening support structure to the flexible hood structure.

In another embodiment, the invention is a method of using a respirator hood assembly to protect a wearer from a respiratory hazard. A flexible hood comprising a filtered air inlet, an exhaust system including at least one check valve, and a transparent viewing area, wherein the flexible hood contains an opening for insertion of a head of a body of the wearer is provided. A removable stiffening support structure is removably disposing within an interior of the hood to create a stiffened hood assembly. The stiffened hood assembly is placed about the head of the body of the wearer, and sealed to inhibit the respiratory hazard from entering the interior of the hood assembly.

The above summary of the present invention is not intended to describe each disclosed embodiment or every implementation of the present invention. The figures and the detailed description which follow more particularly exemplify illustrative embodiments.

### BRIEF DESCRIPTION OF THE DRAWINGS

The present invention is further explained with reference to the drawing figures, wherein like structures are referred to by like numbers throughout the several views.

FIG. 1 is a perspective view of a person wearing a respirator hood.

FIG. 2 is a perspective view of a person wearing a respirator hood assembly containing a structural insert of the present invention.

FIG. 3. is a plan view of the insert outside of the hood assembly.

FIG. 4 is a perspective view of the insert being installed into the hood assembly.

FIG. 5 is a cross-sectional view of the hood assembly taken along line 5-5 of FIG. 2.

FIG. 6 is a plan view of an alternate embodiment of the insert for a flexible hood

While the above-identified drawings set forth multiple embodiments of the present invention, other embodiments are also contemplated, as noted in the discussion. In all cases, this disclosure presents the present invention by way of representation and not limitation. It should be understood that numerous other modifications and embodiments can be devised by those skilled in the art which fall within the scope and spirit of the principles of this invention.

### Glossary

“draws taut” means pulled or drawn tight, not slack.

“expanded upright position” means the shape taken by the respirator hood upon insertion of the removable support structure.

“optical properties” means a characteristic, trait, or capability relating to sight as well as characteristics or capabilities relating to the protection of the eyes.

“removable stiffening support structure” means an insert capable of manipulation for insertion and extraction into the respirator hood which adds structure to the respirator hood and draws taut the outer skin layer.

“stiffened hood assembly” means the respirator hood with an insert which reinforces the hood material and makes the sidewall more difficult to move, deform, or bend.

“transparent viewing area” means the portion of the respirator hood capable of transmitting light so that objects or images of the environment are visible to the wearer.

### DETAILED DESCRIPTION OF THE PREFERRED EMBODIMENTS

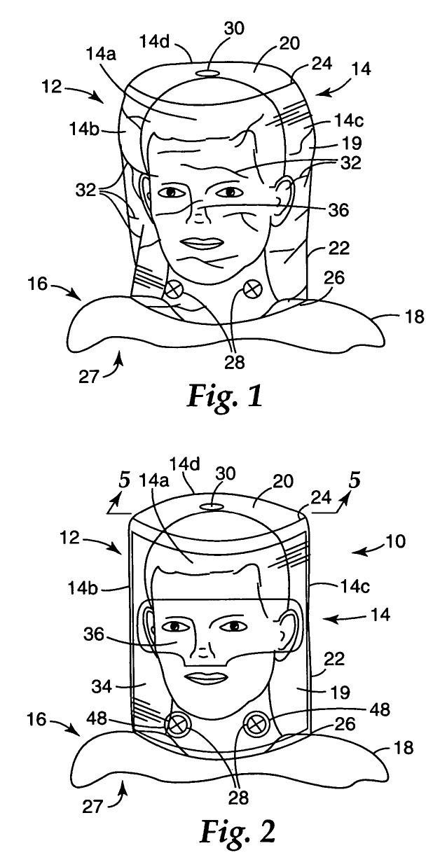

FIG. 1 is a perspective view of a person wearing a respirator hood 14. Such respirator hoods are known within the art. Respirator hoods such as the one illustrated are flexible hoods. Flexible hoods are used in pharmaceutical, medical, military, and nuclear industries as well as related industries. Respirator hoods provide a high level of respirator protection for a wearer relative to a full body suit. Respirator hoods may be reusable, even for years, depending on the environment of use.

The respirator hood 14 comprises an upper portion 12, and a lower portion 16 including a shroud 18. In the embodiment illustrated, the hood 14 is comprised of an outer skin layer 19 of a gas impervious material. For example, the outer skin layer 19 of the hood 14 may be constructed of a 0.5 mm thick sheet of polyurethane. The hood material is chemical resistant yet environmentally friendly. Other polymers, including polyvinyl chloride (PVC), or coated fabrics, are also used in the construction of such respirator hoods. As illustrated, the hood 14 is transparent. In alternate embodiments, hood 14 may contain a non-transparent, opaque, or colored portion with a transparent visor portion which allows the wearer visibility through a portion of the outer layer skin 19 of the hood 14.

In FIG. 1, the hood 14 as illustrated is constructed from two pieces of material, a circular top 20 and a cylindrical side wall 22, which are connected by seam 24. Seam 24 joins the wall 22 and top 20 together by heat sealing, adhesives, radio frequency (RF) welding, dielectric sealing, or similar permanent attachment which is gas impermeable. The hood 14 has a front portion 14a, left and right side portions 14b and 14c, and a rear portion 14d.

The shroud 18 may be constructed from the same or similar flexible, gas impervious material. The shroud 18 need not be transparent. The shroud acts to cover the neck and shoulder portions the body of the wearer and typically includes structure for inhibiting air from entering the interior of the hood 14. The hood and shroud are connected via a seam 26, which may be a heat-sealed seam or other similar permanent attachment similar to seam 24. The shroud 18 contains an opening 27 which allows the head of a wearer to be inserted into the hood 14.

The hood 14 also includes one or more one-way valves 28. Each one-way valve 28 allows air from the interior of the hood 14 to escape while preventing the outside air from entering the interior of the hood 14. The hood 14 also contains an air inlet 30. Typically, the air inlet 30 is connected to a hose (not shown) that runs to a filtering system (not shown) which filters the outside air and transfers the filtered air to the interior of the hood 14. This prevents the wearer from coming in contact with the outside air, which may be unsuitable for unfiltered breathing.

Because the hood 14 is made of a flexible material, the outer skin layer 19 of the hood 14 is allowed to flex which creates folds, undulations, and creases 32 within the hood 14. When disposed within that portion of the hood 14 which serves as a viewing area 36 for a wearer, the creases 32 create visual distortions for the wearer, as well as create physical distractions by allowing the hood 14 to come in contact with the face or head of the wearer. The viewing area 36 extends across the front portion 14a and in many cases at least into the side portions 14b and 14c thereof.

FIG. 2 is a perspective view of a person wearing a respirator hood assembly 10 containing a structural insert 34 of the present invention. As illustrated, respirator hood assembly 10 comprises hood 14 having top portion 12 and lower portion 16, which includes shroud 18. In addition, insert 34 is present as part of the respirator hood assembly 10. Insert 34 is a removable stiffening support structure made from a sheet of material, and which is inserted into opening 27 to create a stiffened hood assembly structure. Upon insertion, the insert 34 acts to draw taut portions of the outer skin layer 19 of the hood 14 (including at least portions of the sides 14b and 14c and front 14a thereof, and the viewing area 36 thereof) in order to remove any creases from a viewing area 36 of the wearer, which leaves a generally smooth surface.

In one embodiment, insert 34 is a sheet of polyethylene terephthalate glycol (PETG) having a thickness of 0.75 mm. Alternatively, insert 34 is constructed from a sheet of polycarbonate, acetate, or a crystalline polymer or similar material. Insert 34 is sufficiently flexible that it is capable of being deformed for insertion into the hood assembly 10. The flexibility of the insert 34 is varied relative to the flexibility of the outer skin layer 19 of the hood 14 to obtain a desired balance between flexibility and stiffness of the hood assembly 10. For instance, hood assembly 10 stiffness can be adjusted or regulated by varying the ratio of the thickness of the insert 34 to the thickness of the outer skin layer 19 of the hood 14, and/or by varying the relative materials. In one embodiment, the thickness of the insert 34 is one and one-half times the thickness of the outer skin layer 19. As can be seen when comparing FIG. 1 to FIG. 2, with the insertion of the insert 34 into the hood 14, the creases 32 have been eliminated and the hood 14 is structurally supported in an upright position by the insert 34. The insert 34 is of a thickness to provide enough stiffness to support the side wall 22 and create a cylindrical structure in the hood assembly 10.

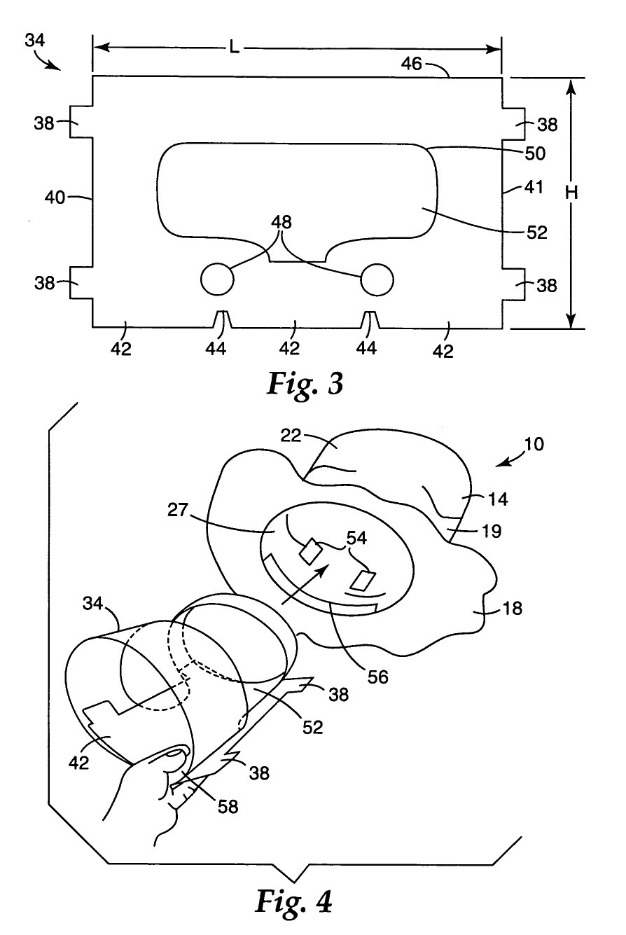

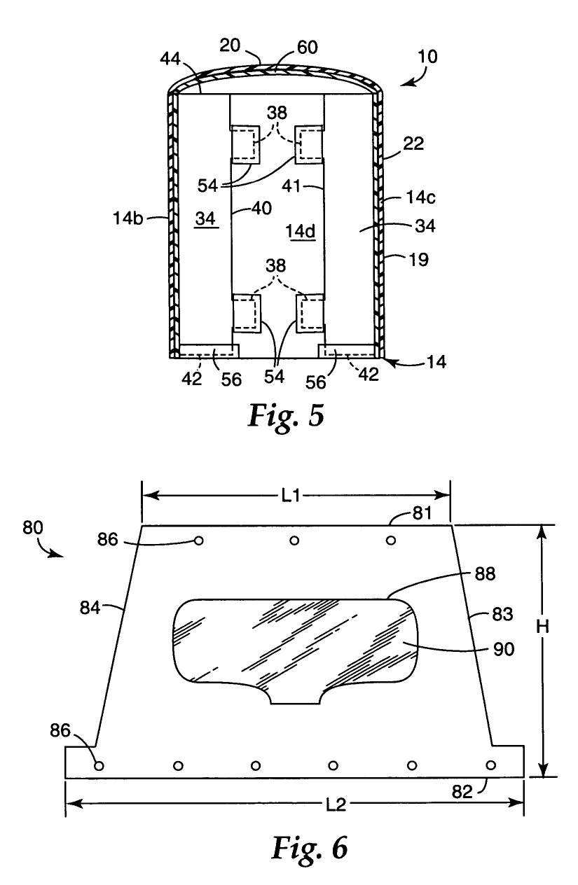

FIG. 3. is a plan view of insert 34 outside of the hood assembly 10. In one embodiment, insert 34 is generally rectangular in shape and includes a top edge 46, a bottom edge 44, and side edges 40 and 41. Insert 34 contains one or more tabs 38 extending from each of the side edges 40 and 41. Similarly, one or more tabs 42 may extend from the bottom edge 44. In the illustrated embodiment, top edge 46 contains no tabs, and is fabricated as a straight edge to support a hard cap structure 60 upon the manipulation of the insert 34 (as visible in FIG. 5). A height H of the side edges 40 and 41 (and insert 34) corresponds generally to a height of the sidewall 22 of the hood 14. A length L of the top edge 46 and bottom edge 44 (and insert 34) is at least a portion of the circumference of the top 20 of hood 14. The specific dimensions of insert 34 are dependent on the dimensions of the hood 14, and the relative placement of fastening means between the insert 34 and hood 14.

In the illustrated embodiment, insert 34 also contains apertures 48 which allow for placement of the insert 34 around the one-way valves 28 of the hood 14. In the embodiment illustrated in FIG. 3, a portion of the material has been removed from the sheet of insert 34 as defined by perimeter 50, thereby creating aperture 52. When insert 34 is placed within the hood assembly 10, the aperture 52 is aligned with the viewing area 36 to allow the wearer with an unobstructed view through only the taut, relatively wrinkle free and transparent outer skin layer 19 of the hood 14.

FIG. 4 is a perspective view of the insert 34 being installed into a hood 14. In FIG. 4, insert 34 is manipulated by rolling the sheet into a cylinder which has a smaller outer circumference than the perimeter of the opening 27 of the shroud 18. Once the insert 34 has been placed into the interior of the hood 14, the insert 34 is manipulated so tabs 38 and 42 will be inserted into pockets 54 and 56, respectively, within hood 14. This temporarily secures the insert 34 within the hood 14.

Insert 34 is manufactured as a flat sheet. The sheet is pliable and flexible to allow the sheet to be rolled into a generally cylindrical or conical shape for insertion into the interior of the hood 14. As illustrated in FIG. 4, the wearer has rolled the sheet of insert 34 into a cylinder for insertion into hood 14. The wearer is gripping an overlapped area 58 of the insert 34 in its rolled form for insertion. Because the insert 34 is formed as a single flat sheet, the insert wants to flatten out or unroll once the wearer has released the grip of the overlapped area 58. The spring force of the sheet will cause the insert 34 to expand until contacting the flexible sidewall 22 (outer skin layer 19), forcing the side wall 22 to assume the cylindrical shape of the insert 34 (which, as mentioned above, while flexible, is formed of a stiffer material than the out skin layer 19 of the hood 14). The outer skin layer 19 is thus pulled taut, meaning that it assumes the shape of the insert 34 and that creases and wrinkles in the outer skin layer 19 are smoothed out as the outer skin layer 19 is pulled against the surface of the insert 34.

FIG. 5 is a cross-sectional view of hood assembly 10 taken along line 5-5 of FIG. 2. FIG. 5 illustrates the hood 14 containing a hard cap section 60 in its interior, as well as pockets 54 on an inner surface of the side wall 22, on the rear portion 14d thereof. Portions of pockets 56 are also shown on the inner surface of the side wall 22, adjacent a bottom edge thereof. Insert 34 is also within the interior of the hood 14, and has its tabs 38 and 42 inserted into pockets 54 and 56, respectively. Side edges 40 and 41 of the insert 34 do not meet. The pockets 54 are positioned to correspond so that when the tabs 38 are inserted therein, insert 34 is a generally cylindrical shape which comes into contact and stretches the material of the flexible hood 14 to form a generally cylindrical cavity inside the hood. The top edge 44 of the insert 34 contacts the hard cap 60, while the tabs 42 are inserted into pockets 56 to further align the insert 34 within the hood 14 to facilitate the stretching and drawing taut of the material of the hood 14. Thus, with the insert 34 installed in the hood 14, the hood assumes a generally cylindrical shape.

The hard cap 60 contains a concave bottom surface for reception of the head of a wearer. The concave bottom surface is generally centrally located within the top 20 of the hood 14. Thus, with the insert 34 installed and the hood 14 placed on the head of a wearer, the hard cap 60 positions the hood 14 about the head of the wearer, leaving space between the face and back of the head of the wearer and the interior of the hood 14. Thus, the material of the side wall 22 of the hood 14 is inhibited from coming in contact with the head of the wearer, so as not to distract or irritate the wearer.

FIG. 6 is a plan view of an alternate embodiment of a stiffening insert for a flexible hood. In the embodiment illustrated, an insert 80 contains an outer perimeter generally in the shape of a trapezoid of a height H with a top edge 81 (having a length L1), a bottom edge 82 (having a length L2), and two side edges 83 and 84. The height H corresponds generally to a height of the sidewall 22 of the hood 14. The lengths L1 and L2 of the top edge 80 and bottom edge 82 are at least a portion of the circumference of the top 20 and length of seam 26 of hood 14. As illustrated, the length L1 of the top edge is smaller than the length L2 of the bottom edge. In an alternate embodiment, the length L1 is greater than the length L2.

Insert 80 contains a series of fasteners 86 about the upper and lower parallel sides. In the embodiment illustrated in FIG. 6, fasteners 86 are snaps or other interlocking elements, with the snaps located on insert 80. The corresponding sockets or other interlocking elements are located on the interior of the side wall 22 of the hood 14. To install the insert 80, the insert is rolled as illustrated in FIG. 4 and inserted into the opening of the hood 14, and then the corresponding snaps and sockets of fasteners 86 are pressed together to secure the insert 80.

Insert 80 also contains a visor portion 90 as defined by perimeter 88. In this embodiment, the visor portion 90 may be an aperture in the insert 80, or may have different optical properties than that of the rest of insert 80. For example, visor portion 90 may be tinted, polarized, magnify, be UV resistant, or a harder material for shielding the eyes of the wearer from airborne debris, or similar properties. The visor portion 90 may also include a structural pattern on the surface such as a micro-replicated surface. Additionally, the visor may be coated with another substance, including a lubricating liquid or silicon prior to installation into the hood assembly 10. Such a micro-replicated surface or lubricant inhibits the formation of air pockets on the contact surface between the visor portion 10 and the inner surface of side wall 22 of hood 14.

The insert 80, including visor portion 90, may contain a coating on the inner surface, that is, the surface closest to the wearer. The coating can comprise or further aid optical properties. For example, the coating may be an antifogging agent, or a scratch resistant coating to prevent items of the wearer (piercings, eyeglasses, etc.) from marring the surface to create visual obstacles for the wearer. Similarly, visor portion 90 may be formed from a transparent crystalline polymer, while the rest of insert 80 contains a differing optical property (such as being tinted or opaque). Alternately, the insert 80 may be a single sheet containing the same optical properties with no discernable perimeter 88 of a visor portion 90.

In addition to the tabs on insert 34 and fasteners on insert 80, the insert of the present inventive hood assembly could be secured to the hood by any of common fastening means or combination of different fastening means for attaching the materials of the hood and insert. The fasteners could be magnets, and the hood would contain ferrous inserts for the magnets to attract and secure the insert to the hood. The hood may contain pockets or slots while the insert contains corresponding structures such as tabs as previously described, or the insert may be sized so that one or more tabs on one side are received in like slots on the other side of the insert. Alternately, one or more strips of hook tape may be attached near the top edge and bottom edge of an insert, and corresponding loop tape strips attached to the inner surface of the side wall of the hood (or vice versa). Upon insertion and placement of insert into the appropriate area of the interior of the hood, each opposed pair of the hook-and-loop tape strips are pressed together to secure the insert in place. An insert can also be secured by sewing or lacing the hood to he insert using a heavy gage thread. A repositionable pressure sensitive adhesive may be applied to the outer perimeter of an insert so that upon placement of the insert within the hood, the wearer presses the hood and insert together to activate the adhesive. The term “repositionable” means that the insert containing the adhesive can be adhered to and removed from a clean solid surface at least two times without substantially losing tack. Similarly, the material of the hood may be designed and fabricated to contain a static sling film that will secure an insert upon contact with the interior of the side wall of the hood.

Inserts 34 and 80 are removable from hood 14. This creates the advantage, with the insert removed, of increased flexibility of the hood 14 so that it can fit into more areas than if it was a rigid hood or was supported as a more rigid structure by the inventive insert structure. Also, with the insert removed, the hood can be collapsed and stored relatively flat until it is required for use (and the insert can be stored in its flattened state as well). When a stiffened hood is required, the insert may again be inserted and secured relative to the hood 14, assuming the configuration shown in FIG. 2.

As was disclosed previously, a hood with the insert in the embodiment of FIG. 3 installed has a generally cylindrical shape. Insert 80 is a flexible framing assembly for the hood 14 which can create a different shape for the respirator hood assembly 10. Installing the insert 80 into a hood creates a generally uniform viewing area by drawing taut the flexible hood material of the hood 14. The outer skin layer 19 is pulled taut by the insert 80, meaning that creases and wrinkles in the outer skin layer 19 are smoothed out as the outer skin layer 19 of the front portion 14a and part of side portions 14b and 14c are pulled against the surface of the insert 80. The rear portion 14d and/or part of the side portions 14b and 14c are not in contact with the insert 80 leaving a flexible area. This area is created by the difference in the lengths L1 and L2 of the corresponding top edge 81 and bottom edge 82. The result is a structure with a cylindrical side wall, but wherein the top and bottom circular surfaces are not necessarily parallel to each other. The front portion 14a of the hood 14 will be stabilized for viewing, while an area of the back portion 14d of the hood 14 will remain flexible to allow a wearer to get into tighter areas. In all embodiments, inserts of the present invention, when the insert is mounted within the interior of the hood, create a generally uniform viewing area which inhibits formation of creases in the flexible hood material.

Although the present invention has been described with reference to preferred embodiments, workers skilled in the art will recognize that changes may be made in form and detail without departing from the spirit and scope of the invention.

What is claimed is:

1. A respirator hood assembly comprising:
a pliable hood including a transparent viewing area; and
a removable stiffening support structure mountable within an interior of the hood, wherein the support structure draws taut the pliable hood to inhibit the formation of creases in the transparent viewing area.

2. The respirator hood assembly of claim 1 wherein the removable stiffening support structure is fastened to the hood.

3. The respirator hood assembly of claim 1, and further comprising:
a plurality of pockets on the interior of the hood; and
a plurality of tabs on the support structure, wherein at least one tab on the removable stiffening support structure is insertable into a corresponding one of the pockets on the hood for fastening the support structure to the hood.

4. The respirator hood assembly of claim 1 wherein a first portion of the removable stiffening support structure provides different optical properties than the transparent viewing area of the hood.

5. The respirator hood assembly of claim 4 wherein the first portion of the removable stiffening support structure is aligned with the transparent viewing area of the hood.

6. The respirator hood assembly of claim 4 wherein the first portion of the removable stiffening support structure is aligned with a section the pliable hood other than the transparent viewing area thereof.

7. The respirator hood assembly of claim 1, wherein prior to being mounted within the interior of the hood, the removable stiffening support structure comprises:
a flexible, generally planar sheet which is capable of manipulation to permit insertion thereof through opening in a lower portion of the hood.

8. The respirator hood assembly of claim 1 wherein the removable stiffening support structure has an aperture therethrough which, when the support structure is mounted within the interior of the hood, is aligned with the transparent viewing area of the hood.

9. An improvement for a respirator hood assembly having a gas impermeable hood made of a flexible material, the material of the gas impermeable hood having a transparent viewing area, a filtered air inlet to receive breathable air into the hood, at least one check valve for facilitating the exhausting of gas from the hood, and a portion for securing the hood about a head of a wearer, the improvement which comprises:
a removable stiffening support structure attached within an interior of the hood, the support structure being sufficiently rigid to maintain the hood in an expanded upright position and to draw taut the transparent viewing area to enhance wearer viewability therethrough.

10. The improvement of claim 9 wherein the removable stiffening support structure comprises:
a flexible, generally planar sheet which is capable of being deformed for insertion into the interior of the hood.

11. The improvement of claim 9, and further comprising:
a fastener capable of securing the removable stiffening support structure with respect to the gas impermeable hood.

12. The improvement of claim 11, wherein the fastener is selected from the group consisting of one or more tabs, slots, interlocking elements, or magnets disposed around a perimeter of the sheet, one or more strips of hook and loop fasteners, adhesives, or static cling between the removable stiffening support structure and the gas impermeable hood, or combinations thereof.

13. The improvement of claim 9 wherein a first portion of the removable stiffening support structure provides different optical properties then the transparent viewing area of the gas impermeable hood.

14. The respirator hood assembly of claim 13 wherein the first portion of the removable stiffening support structure is aligned with the transparent viewing area of the gas impermeable hood.

15. The respirator hood assembly of claim 13 wherein the first portion of the removable stiffening support structure is aligned with a section the gas impermeable hood other than the transparent viewing area thereof.

16. The improvement of claim 9 wherein the removable stiffening support structure has an aperture therethrough which, when the support structure is mounted within the interior of the hood, is aligned with the transparent viewing area of the hood.

17. A method of using a respirator hood assembly to protect a wearer from a respiratory hazard, the method comprising:
providing a flexible hood comprising a filtered air inlet, an exhaust system including at least one check valve, and a transparent viewing area, wherein the flexible hood contains an opening for insertion of a head of a body of the wearer;
disposing a removable stiffening support structure within an interior of the hood to create a stiffened hood assembly;
placing the stiffened hood assembly about the head of the body of the wearer;
sealing the stiffened hood assembly about the wearer to inhibit the respiratory hazard from entering the interior of the stiffened hood assembly.

18. The method of claim 17, and further comprising:
fastening the removable stiffening support structure to the flexible hood.

19. The method of claim 17, wherein the disposing step comprises:
manipulating the removable stiffening support structure from a first generally planar position to a second three dimensional position.

20. The method of claim 17 wherein the disposing step comprises:
providing a plurality of tabs on of the stiffening support; and
inserting at least one tab into a respective tab receptacle formed on the interior of the flexible hood.

21. The method of claim 17 wherein the removable stiffening support structure has an aperture which, when the stiffening support is disposed within the interior of the hood, is aligned with the transparent viewing area of the hood.

22. A respirator hood assembly comprising:
a flexible hood structure having a first condition wherein the hood structure is collapsed for storage and transport and a second condition wherein the hood structure is expanded for respiratory use;
a removable stiffening support structure for the hood structure which, when attached to the hood structure, places the hood structure in its second condition whereby at least a front portion of the hood structure including a transparent viewing area and sides of the hood structure are drawn taut; and
means for attaching the removable stiffening support structure to the flexible hood structure.

23. The respirator hood assembly of claim 22 wherein the removable stiffening support structure is a single sheet of material.

24. The respirator hood assembly of claim 22 wherein the removable stiffening support structure is inserted within hood structure.

25. The respirator hood assembly of claim 22 wherein means for attaching is selected from the group consisting of one or more tabs, slots, interlocking elements, snaps, hook and loop fasteners, magnets, adhesives, sewing the flexible hood to the flexible framing assembly, static cling between the material of the removable stiffening support structure and the material of the flexible hood, or combinations thereof.
